(19) United States
(12) Patent Application Publication
(10) Pub. No.: US 2021/0382735 A1
(43) Pub. Date: Dec. 9, 2021

(54) HUMAN ERROR PREVENTION DEVICE, HUMAN ERROR PREVENTION METHOD, AND PROGRAM THEREFOR

(71) Applicant: NEC Corporation, Tokyo (JP)

(72) Inventor: Takayuki SUZUKI, Tokyo (JP)

(73) Assignee: NEC Corporation, Tokyo (JP)

(21) Appl. No.: 16/625,537

(22) PCT Filed: Jun. 11, 2018
(86) PCT No.: PCT/JP2018/022214

§ 371 Date: Dec. 20, 2019

(30) Foreign Application Priority Data
Jun. 27, 2017 (JP) 2017-125138

(51) Int. Cl. G06F 9/451; G06F 3/01

(52) U.S. Cl. CPC G06F 9/453; G06F 3/013

(57) ABSTRACT

A human error prevention device includes: an acquisition unit configured to acquire task information based on an operation of a user carrying out a task and including task identification information for identifying a task and input information based on an input operation performed in the task corresponding to the task identification information and acquires confirmation completion information based on an operation of a user carrying out confirmation of the input operation; and a determination unit configured to determine whether to perform a process corresponding to the input operation on the basis of the task information and the confirmation completion information.

### TECHNICAL FIELD

The present invention relates to a human error prevention device, a human error prevention method, and a program therefor.

### BACKGROUND ART

In various operations using computers, appropriate operations may not be performed due to input errors based on human errors and, as a result, task errors are likely to be generated. A device for preventing such human errors is desired. Patent Documents 1 and 2 disclose technologies for assisting input operations of users.

### CITATION LIST

### Patent Literature

### [Patent Document 1]

Japanese Patent No. 5927366

### [Patent Document 2]

Japanese Unexamined Patent Application, First Publication No. 2016-35621

### SUMMARY OF INVENTION

### Problem to be Solved by the Invention

However, there is no technology of mitigating input operation errors due to human errors.

Therefore, an object of the present invention is to provide a human error prevention device, a human error prevention method and a program capable of solving the aforementioned problem.

### Means for Solving the Problem

According to a first aspect of the present invention, a human error prevention device includes: an acquisition unit configured to acquire task information based on an operation of a user carrying out a task and including task identification information for identifying a task and input information based on an input operation performed in the task corresponding to the task identification information and acquires confirmation completion information based on an operation of a user carrying out confirmation of the input operation; and a determination unit configured to determine whether to perform a process corresponding to the input operation on the basis of the task information and the confirmation completion information.

According to a second aspect of the present invention, a human error prevention method includes: acquiring task information based on an operation of a user carrying out a task and including task identification information for identifying a task and input information based on an input operation performed in the task corresponding to the task identification information and acquiring confirmation completion information based on an operation of a user carrying out confirmation of the input operation; and determining whether to perform a process corresponding to the input operation on the basis of the task information and the confirmation completion information.

According to a third aspect of the present invention, a program causes a computer of a human error prevention device to execute processes of: acquiring task information based on an operation of a user carrying out a task and including task identification information for identifying a task and input information based on an input operation performed in the task corresponding to the task identification information and acquiring confirmation completion information based on an operation of a user carrying out confirmation of the input operation; and determining whether to perform a process corresponding to the input operation on the basis of the task information and the confirmation completion information.

### Advantageous Effects of Invention

According to the present invention, the effect of preventing human errors in a task such as an input operation for a computer is obtained.

### BRIEF DESCRIPTION OF DRAWINGS

FIG. 1 is a block diagram showing a configuration of a human error prevention system in a first embodiment.

FIG. 2 is a functional block diagram of a human error prevention device in the first embodiment.

FIG. 3 is a diagram showing an example of a procedure document in the first embodiment.

FIG. 4 is a diagram showing a process flow of the human error prevention device in the first embodiment.

FIG. 5 is a block diagram showing a configuration of a human error prevention system in a second embodiment.

FIG. 6 is a diagram showing a process flow of the human error prevention device in the second embodiment.

### DESCRIPTION OF EMBODIMENTS

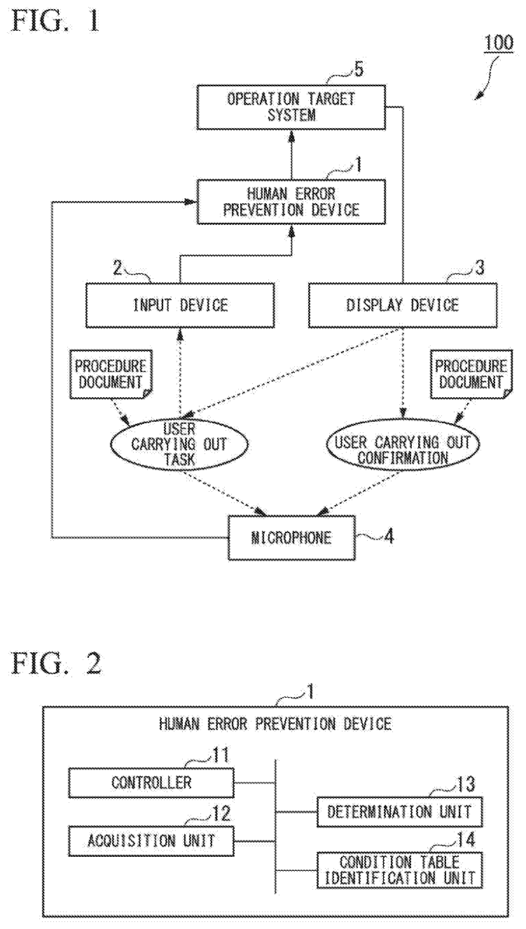

Hereinafter, a human error prevention device according to an embodiment will be described with reference to the drawings. FIG. 1 is a block diagram showing a configuration of a human error prevention system including a human error prevention device in a first embodiment.

As shown in this drawing, a human error prevention system 100 includes a human error prevention device 1, an input device 2, a display device 3, a microphone 4, and an operation target system 5.

The human error prevention device 1 mitigates and prevents human errors in an input operation of a user carrying out a task for the operation target system 5.

The input device 2 is a device which receives an input operation from the user carrying out a task, such as a keyboard and a touch panel.

The display device 3 is a device which displays output information of the operation target system 5, such as a monitor.

The microphone 4 collects speech (utterances) generated by a user carrying out a task and a user carrying out confirmation, converts the collected speech into signals and outputs the signals to the human error prevention device 1.

The operation target system 5 is a device which receives information from the input device 2 according to an input operation of the user carrying out a task and performs a process on the basis of the information.

The human error prevention device 1 and the operation target system 5 are computers including a central processing unit (CPU), a read only memory (ROM), a random access memory (RAM), a hard disk drive (HDD), a communication module, and the like. The input device 2 and the display device 3 may also have this hardware configuration.

The human error prevention system 100 shown in FIG. 1 is simultaneously used by the user carrying out a task and the user carrying out confirmation. The user carrying out a task is a user who operates the operation target system 5 using the input device 2. The user carrying out confirmation is a user who checks an operation performed by the user carrying out a task. The user carrying out a task and the user carrying out confirmation check (visually recognize) the same procedure document. Then, the user carrying out a task performs an input operation on the input device 2. When the input operation is performed, the operation target system 5 acquires input information input through the input operation. The operation target system 5 outputs the input information to the display device 3. The user carrying out a task and the user carrying out confirmation check (visually recognize) the input information displayed on the display device 3. The human error prevention device 1 determines presence or absence of a human error on the basis of input information based on an input operation of the user carrying out a task and input information based on a confirmation task of the user carrying out confirmation.

FIG. 2 is a functional block diagram of the human error prevention device in the first embodiment.

The human error prevention device 1 stores a human error prevention program and executes the program. Accordingly, the human error prevention device 1 has functions of a controller 11, an acquisition unit 12, a determination unit 13 and a condition table identification unit 14.

The controller 11 controls other functional units of the human error prevention device 1.

The acquisition unit 12 acquires task information based on an operation of a user carrying out a task from the input device 2 used by the user carrying out a task, and the like. The task information includes task identification information for identifying a task and input information. The task is, for example, an operation of inputting information. The input information is information based on an input operation performed in the task corresponding to the task identification information. In addition, the acquisition unit 12 acquires confirmation completion information based on an operation of a user carrying out confirmation of an input operation of the user carrying out a task. For example, the confirmation completion information may be speech information of the user carrying out confirmation. The microphone 4 receives speech generated by the user carrying out confirmation as an input, converts the speech into a signal and outputs the converted speech information to the human error prevention device 1. The acquisition unit 12 acquires the confirmation completion information that is the speech information as an example.

The determination unit 13 determines whether to perform a process corresponding to the input operation of the user carrying out a task on the basis of the task information and the confirmation completion information and outputs a determination result to the operation target system 5. The operation target system 5 performs a process based on information on the input operation included in the determination result when the determination unit 13 determines that the process is to be performed.

The condition table identification unit 14 reads a condition table recorded in a storage unit of the human error prevention device on the basis of procedure document identification information acquired by the acquisition unit 12.

The human error prevention device 1 according to the present embodiment mitigates or prevents a human error in an input operation performed by a user carrying out a task through the processes of the aforementioned functional units.

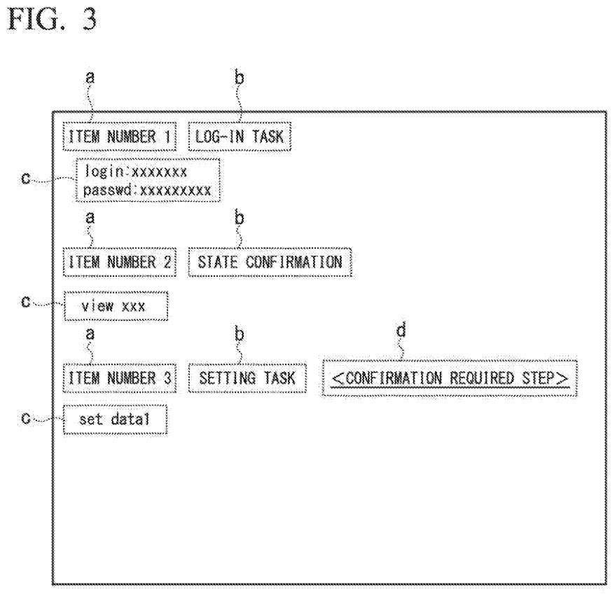

FIG. 3 is a diagram showing an example of a procedure document in the first embodiment.

The procedure document (FIG. 1) is document information read by a user carrying out a task and a user carrying out confirmation in order to operate the operation target system 5. As an example, the procedure document may state “item number N” a, “information representing task details” b which indicates a type of information input through an input operation corresponding to “item number N” a, and “input information” c corresponding to “item number N” a. Further, “confirmation task presence/absence information” d which represents whether a confirmation task of a user carrying out confirmation is required is stated corresponding to each “item number N” a in the procedure document.

According to the example of FIG. 3, “information representing task details” b corresponding to “item number 3” a is information input in an input operation of “setting task” and “input information” c is “set data1.” Further, “confirmation task presence/absence information” d corresponding to “item number 3” a is “confirmation required step” and represents that a confirmation task is required.

### First Embodiment

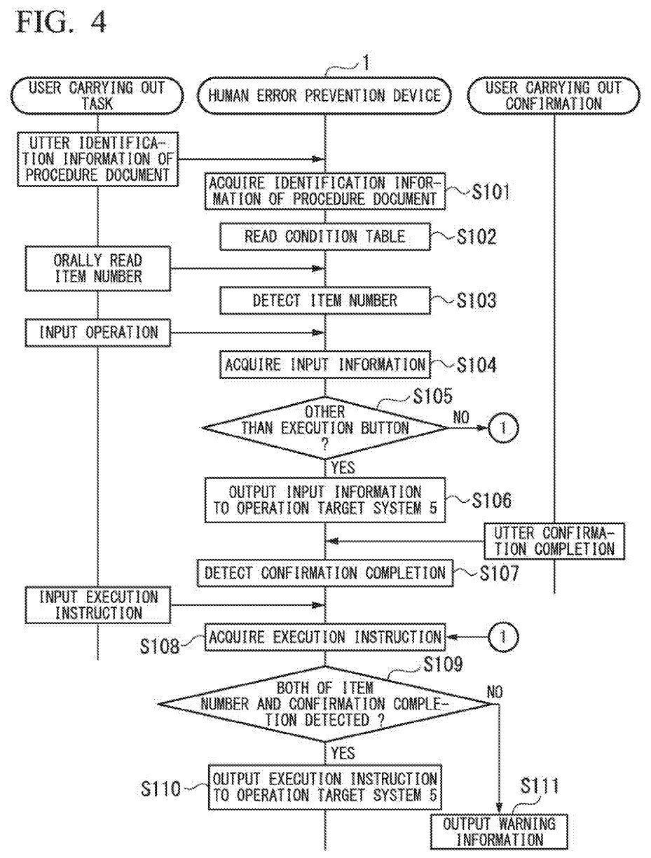

FIG. 4 is a diagram showing a process flow of the human error prevention device in the first embodiment.

Next, processes of the human error prevention device 1 according to the first embodiment will be described in order.

A user carrying out a task operates the operation target system 5 while checking a procedure document. The degree of mitigation of human errors is improved by operating the operation target system 5 while checking the procedure document.

The user carrying out a task orally utters identification information of the procedure document. Alternatively, the user carrying out a task inputs the identification information of the procedure document to the input device 2. When the user carrying out a task orally utters the identification information of the procedure document, the microphone 4 collects the speech of the identification information of the procedure document and outputs a speech signal obtained by converting the collected speech into a signal to the human error prevention device 1. The input device 2 receives the identification information of the procedure document and outputs the identification information of the procedure document to the human error prevention device 1. The acquisition unit 12 of the human error prevention device 1 acquires the identification information of the procedure document (step S101). In addition, the acquisition unit 12 outputs the identification information of the procedure document to the determination unit 13. Accordingly, the human error prevention device 1 identifies the identification information of the procedure document corresponding to an input operation performed on the operation target system 5.

The condition table identification unit 14 reads a condition table recorded corresponding to the identification information of the procedure document from the storage unit (step S102).

A condition table is, for example, a data table in which item numbers, input information corresponding to the item numbers, a list of item numbers acquired through confirmation tasks and the order of the item numbers, confirmation task presence/absence information, and the like are associated and stored for each piece of identification information of the procedure document. The condition table records information written on the procedure document shown in FIG. 3. Further, with respect to a plurality of item numbers (task identification information), the condition table may store information on the order of tasks corresponding to the respective item numbers. That is, the condition table may store information on the order of a plurality of input operations. Meanwhile, the identification information of the procedure document and item numbers are an aspect of task identification information. The confirmation task presence/absence information is information representing whether a confirmation task is necessary.

The user carrying out a task and the user carrying out confirmation start to operate the operation target system 5 in cooperation. Here, the user carrying out a task reads aloud an item number written on the procedure document. The microphone 4 converts the speech of the item number uttered by the user carrying out a task into a signal and outputs the converted signal to the human error prevention device 1. The acquisition unit 12 performs a speech recognition process on the signal input from the microphone 4 to detect the item number (step S103).

In addition, the user carrying out a task performs an input operation for input information stated in the procedure document corresponding to the read item number on the input device 2. The input device 2 outputs the input information based on the input operation to the human error prevention device 1. The acquisition unit 12 acquires the input information (step S104).

In this manner, the human error prevention device 1 acquires the information on the item number uttered by the user carrying out a task and the input information input by the user carrying out a task. The human error prevention device 1 acquires task information acquired according to an operation of the user carrying out a task. That is, the human error prevention device 1 acquires task information based on an operation of the user carrying out a task.

The acquisition unit 12 of the human error prevention device 1 determines whether the input information acquired through the input operation of the user carrying out a task is information other than an execution button (step S105). When the input information is input of information other than the execution button (YES in step S105), for example, the acquisition unit 12 outputs the input information to the operation target system 5 (step S106). The operation target system 5 outputs the input information acquired from the human error prevention device 1 to the display device 3.

The user carrying out confirmation checks the information displayed on the display device 3. The information displayed on the display device 3 is information input to the input device 2 according to the input operation of the user carrying out a task in step S104. This information is input information according to the input operation of the user carrying out a task. The user carrying out confirmation checks whether the information displayed on the display device 3 is consistent with the input information corresponding to the item number (step S103) in the procedure document which has been read by the user carrying out a task. The user carrying out confirmation utters a predetermined confirmation completion word when the information is consistent with the input information. For example, the user carrying out confirmation utters a word such as “checked.” The microphone 4 converts the speech uttered by the user carrying out confirmation into a signal and outputs the converted signal to the human error prevention device 1. The acquisition unit 12 performs a speech recognition process on the signal input from the microphone 4 and detects that the speech signal is a word representing completion of confirmation (step S107).

In this manner, the user carrying out confirmation compares the input information input on the basis of the input operation performed by the user carrying out a task with the input information in the procedure document corresponding to the item number read by the user carrying out a task. The user carrying out confirmation utters speech representing completion of confirmation when both are consistent with each other. The human error prevention device 1 acquires a signal acquired according to the speech uttered by the user carrying out confirmation as confirmation completion information. That is, the human error prevention device 1 acquires the confirmation completion information based on the operation of the user carrying out confirmation.

The user carrying out a task confirms that the user carrying out confirmation has uttered the confirmation completion word and then input an execution instruction to the input device 2. The execution instruction is an operation of inputting an execution command, for example. The input device 2 outputs information on the execution instruction to the human error prevention device 1. The acquisition unit 12 acquires the information on the execution instruction and outputs the information to the determination unit 13. The information on the execution instruction is an aspect of input information according to an input operation. The determination unit 13 acquires the execution instruction (step S108).

Alternatively, the determination unit 13 proceeds to step S108 when it is determined that the input information acquired in step S104 is the execution instruction in step S105 (NO in step S105). The determination unit 13 acquires the execution instruction when the input information represents input of the execution button, for example.

When the determination unit 13 acquires the execution instruction, the determination unit 13 determines whether both the item number (step S103) and the word representing completion of confirmation (step S107) have been detected (step S109). The determination unit 13 determines that the execution instruction is to be output to the operation target system 5 when both the item number and the word representing completion of confirmation have been detected (YES in step S109). In this manner, the determination unit 13 determines whether to perform a process corresponding to the input operation on the basis of the task information and the confirmation completion information based on the operation of the user carrying out confirmation.

The determination unit 13 outputs the execution instruction to the operation target system 5 (step S110). The operation target system 5 executes the process corresponding to the input information on the basis of the input information acquired from the human error prevention device 1 and the execution instruction.

When both the item number and the word representing completion of confirmation have not been detected in step S109 (NO in step S109), the determination unit 13 outputs warning information to the display device 3 (step S111). Specifically, when the item number has not been detected before the execution instruction is acquired, the determination unit 13 outputs warning information representing that no item number has been input. Alternatively, when completion of confirmation has not been detected before the execution instruction is acquired, the determination unit 13 outputs warning information representing that completion of confirmation has not been input.

In the above-described process, the determination unit 13 may determine whether the input information acquired in step S104 is consistent with the input information recorded in the condition table in association with the item number detected in step S103 before the input information of step S106 is output. Then, the determination unit 13 may output the input information to the operation target system 5 only when they are consistent with each other and output warning information when they are not consistent with each other. Accordingly, both the human error prevention device 1 and the user carrying out confirmation perform an input information confirmation task.

In this manner, the human error prevention device 1 acquires task identification information and input information based on an operation of the user carrying out a task. The human error prevention device 1 may determine that a process corresponding to an input operation is to be performed when input information stored in advance corresponding to the acquired task identification information is consistent with input information based on an operation of the user carrying out a task. In other words, the human error prevention device 1 determines that the process corresponding to the input operation is to be performed when it is determined that the task identification information and the input information are consistent with each other in a predetermined corresponding relationship and task information and confirmation completion information have been acquired. Accordingly, it is possible to more effectively minimize input information error.

According to the above-described processes of the human error prevention device 1, the human error prevention device 1 confirms acquisition of both an item number that is details of a task and information on completion of confirmation of input of input information of the details of the task corresponding to the item number from the microphone 4 and then instructs the operation target system 5 to perform a process corresponding to the input information. Accordingly, it is possible to further promote mitigation and prevention of human errors.

In this manner, the human error prevention device 1 acquires task information based on an operation of the user carrying out a task and acquires confirmation completion information based on an operation of a user carrying out confirmation of the input operation indicated by the task information. The human error prevention device 1 determines whether to perform a process corresponding to the input operation on the basis of the task information and the confirmation completion information. Accordingly, the human error prevention device 1 can effectively prevent human errors in a task such as an input operation performed on a computer.

According to the above-described human error prevention system 100 shown in FIG. 1, an aspect having only one microphone 4 is shown. However, in the human error prevention system 100, a user carrying out a task and a user carrying out confirmation may have different microphones 4. For example, the user carrying out a task and the user carrying out confirmation may wear headset microphones corresponding to the microphone 4 on their heads and the headset microphones may transmit audio signals to the human error prevention device 1 in a wireless manner or the like.

In addition, according to the above-described human error prevention system 100, an aspect having only one display device 3 is shown. However, the human error prevention system 100 may have different display devices 3 respectively corresponding to the user carrying out a task and the user carrying out confirmation.

### Second Embodiment

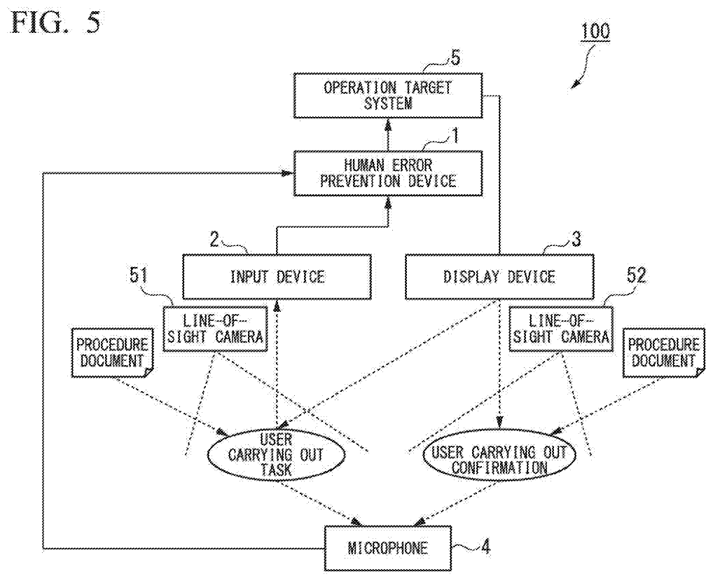

FIG. 5 is a block diagram showing a configuration of a human error prevention system including a human error prevention device in a second embodiment.

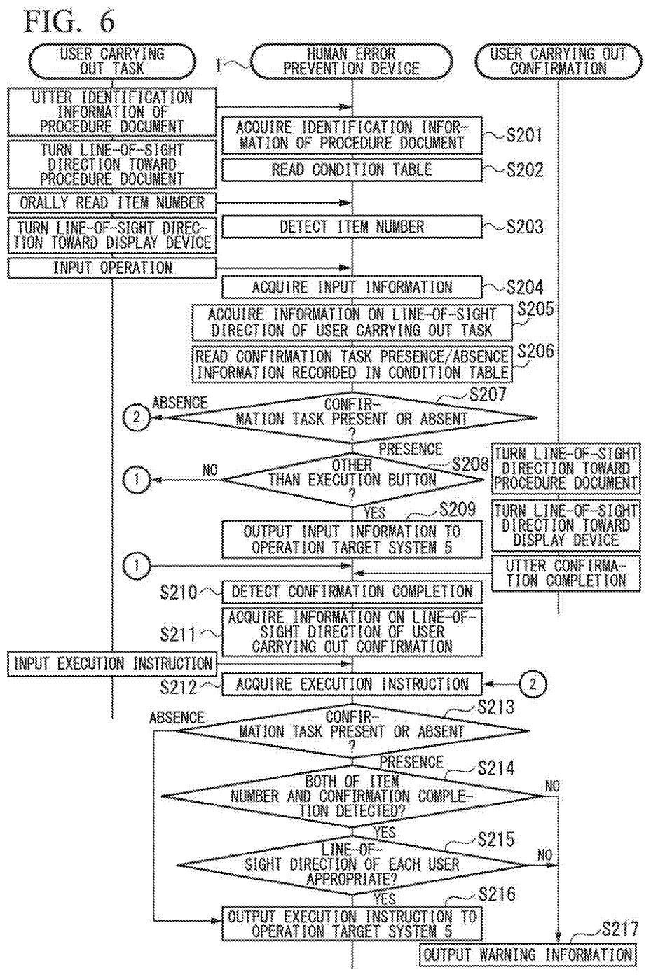

FIG. 6 is a diagram showing a process flow of the human error prevention device in the second embodiment.

Next, processes of the human error prevention device 1 in the second embodiment will be described in order.

The human error prevention system 100 in the second embodiment differs from the first embodiment in that a line of sight camera 51 which is configured to detect a line of sight of a user carrying out a task and a line-of-sight camera 52 which is configured to detect a line of sight of a user carrying out confirmation are further included. Meanwhile, hardware configurations and functional configurations of the human error prevention device 1 and the operation target system 5 in the second embodiment are the same as those of the first embodiment.

First, a user carrying out a task orally utters identification information of a procedure document. Alternatively, the user carrying out a task inputs the identification information of the procedure document to the input device 2 (input operation). When the user carrying out a task orally utters the identification information of the procedure document, the microphone 4 picks up (collects) the speech (utterances) of the identification information of the procedure document and outputs speech information obtained by converting the collected speech into a signal to the human error prevention device 1. Alternatively, the input device 2 outputs the identification information of the procedure document to the human error prevention device 1. The acquisition unit 12 of the human error prevention device 1 acquires the identification information of the procedure document (step S201). In addition, the acquisition unit 12 outputs the identification information of the procedure document to the determination unit 13. Accordingly, the human error prevention device 1 identifies the identification information of the procedure document corresponding to an input operation applied to the operation target system 5.

The determination unit 13 reads a condition table recorded corresponding to the identification information of the procedure document from the storage unit (step S202).

As in the first embodiment, the condition table is, for example, a data table in which item numbers, input information corresponding to the item numbers, a list of item numbers acquired through confirmation tasks and the order of the item numbers, confirmation task presence/absence information, and the like are associated and stored for each piece of identification of the procedure document. Meanwhile, the identification information of the procedure document and item numbers are an aspect of task identification information.

Then, the user carrying out a task and a user carrying out confirmation start to operate the operation target system 5 in cooperation. Here, the user carrying out a task reads aloud an item number written on the procedure document. The microphone 4 converts the speech of the item number uttered by the user carrying out a task into a signal and outputs the converted signal to the human error prevention device 1. The acquisition unit 12 performs a speech recognition process on the signal input from the microphone 4 to detect the item number (step S203).

In addition, the user carrying out a task performs an input operation for input information stated in the procedure document corresponding to the read item number on the input device 2. The input device 2 outputs the input information based on the input operation to the human error prevention device 1. The acquisition unit 12 acquires the input information (step S204).

At this point in time, the line-of-sight camera 51 detects a line of sight of the user carrying out a task and transmits information on the line-of-sight direction of the line of sight to the human error prevention device 1. The acquisition unit 12 of the human error prevention device 1 acquires the information on the line-of-sight direction of the user carrying out a task (step S205). The acquisition unit 12 reads confirmation task presence/absence information recorded in the condition table in association with the item number detected in step S203 (step S206).

The confirmation task presence/absence information is information for the human error prevention device 1 to determine whether to check presence or absence of input of both the item number (step S203) and a word representing completion of confirmation (step S210). The acquisition unit 12 determines whether the confirmation task presence/absence information recorded in the condition table in association with the item number represents “absence” or “presence” (step S207).

In step S207, the acquisition unit 12 performs the following process when the confirmation task presence/absence information recorded in the condition table in association with the item number represents “absence” (“absence” in step S207). That is, the acquisition unit 12 waits for input of an execution instruction from the user carrying out a task and acquires the execution instruction in step S212 described below. In addition, the determination unit 13 determines whether the confirmation task presence/absence information represents “absence” or “presence” as in step S207 (step S213). In this case, the determination unit 13 proceeds with a process without a confirmation task (“absence” in step S213). The acquisition unit 12 immediately outputs the execution instruction to the operation target system 5 through a process of step S216.

On the other hand, the acquisition unit 12 proceeds with the following process when the confirmation task presence/absence information recorded in the condition table in association with the item number represents “presence” (“presence” in step S207).

The acquisition unit 12 determines whether the input information acquired according to the input operation of the user carrying out a task is information other than an execution button (step S208). For example, when the input information is information representing a character input other than the execution button (YES in step S208), the acquisition unit 12 outputs the input information to the operation target system 5 (step S209). The operation target system 5 outputs the input information acquired from the human error prevention device 1 to the display device 3.

Further, determination unit 13 proceeds to step S210 when the input information acquired in step S204 is determined to be the execution instruction in step S208 (NO in step S208).

The user carrying out confirmation turns the line-of-sight direction toward the procedure document and checks input information corresponding to the item number uttered by the user carrying out a task. In addition, the user carrying out confirmation checks the input information from the user carrying out a task which has been output to the display device 3 and determines whether they are consistent with each other. When the information displayed on the display device 3 is consistent with the input information corresponding to the item number in the procedure document read by the user carrying out a task, the user carrying out confirmation utters a predetermined confirmation completion word. For example, the user carrying out confirmation utters a word such as “checked.” The microphone 4 converts the speech uttered by the user carrying out confirmation into a signal and outputs the converted signal to the human error prevention device 1. The acquisition unit 12 performs a speech recognition process on the signal input from the microphone 4 and detects that the speech signal is the word representing completion of confirmation (step S210).

Further, in this point in time, the line-of-sight camera 52 detects the line of sight of the user carrying out confirmation and transmits information on the line-of-sight direction of the line of sight to the human error prevention device 1. The acquisition unit 12 of the human error prevention device 1 acquires the information on the line-of-sight direction of the user carrying out confirmation (step S211).

The user carrying out a task confirms that the user carrying out confirmation has uttered the confirmation completion word and then inputs an execution instruction to the input device 2. The execution instruction is an operation of inputting an execution command, for example. The input device 2 outputs information on the execution instruction to the human error prevention device 1. The acquisition unit 12 acquires the information on the execution instruction and outputs the information to the determination unit 13. The information on the execution instruction is an aspect of input information according to an input operation. The determination unit 13 acquires the execution instruction (step S212). The determination unit 13 determines whether the confirmation task presence/absence information represents “absence” or “presence” as in step S207 (step S213). At this point in time, the determination unit 13 determines presence of a confirmation task (“presence” in step S213). Then, the determination unit 13 determines whether both the item number (step S203) and the word representing completion of confirmation (step S210) have been detected (step S214).

The determination unit 13 determines whether the line-of-sight direction of each user is appropriate on the basis of the information on the line-of-sight direction of the user carrying out a task and the information on the line-of-sight direction of the user carrying out confirmation (step S215) when both the item number and the word representing completion of confirmation have been detected (YES in step S214).

Specifically, a position at which the procedure document is placed and a position at which the display device 3 is installed have been set in advance, for example. Further, a seat position or a head position of each user is a position stored in advance in the human error prevention device 1.

In such a state, the human error prevention device 1 stores a line-of-sight direction when the line of sight has been moved from each user to input information with respect to each item number of the procedure document or input information displayed on the display device 3 in advance. The determination unit 13 acquires information on an appropriate line-of-sight direction of each user in each item number from the storage unit or the like and compares the information on the appropriate line-of-sight direction with information on line-of-sight directions acquired from the line-of-sight cameras 51 and 52.

The determination unit 13 determines that the user carrying out a task is performing visual recognition in an appropriate line-of-sight direction when a line-of-sight direction of the user carrying out a task acquired from the line-of-sight camera 51 has the appropriate line-of-sight direction of the user carrying out a task which corresponds to the item number detected in step S203. Likewise, the determination unit 13 determines that the user carrying out confirmation has performed visual recognition in an appropriate line-of-sight direction when a line-of-sight direction of the user carrying out confirmation acquired from the line-of-sight camera 52 has the appropriate line-of-sight direction of the user carrying out confirmation which corresponds to the item number detected in step S203.

The determination unit 13 determines that the execution instruction is to be output to the operation target system 5 when it is determined that both the line-of-sight direction of the user carrying out a task and the line-of-sight direction of the user carrying out confirmation are appropriate (YES in step S215). Then, the determination unit 13 outputs the execution instruction to the operation target system 5 (step S216). The operation target system 5 performs a process corresponding to the input information on the basis of the input information acquired from the human error prevention device 1 and the execution instruction.

On the other hand, when the determination unit 13 has not detected both the item number and the word representing completion of confirmation in step S214 (NO in step S214) or when it is determined that the line-of-sight direction of at least one of the users is not appropriate in step S215 (NO in step S215), the determination unit 13 outputs warning information to the display device 3 (step S217).

Specifically, the determination unit 13 outputs warning information representing that the item number has not been input when the item number has not been detected before the execution instruction is acquired. In addition, the determination unit 13 outputs warning information representing that confirmation completion has not been input when confirmation completion has not been detected before the execution instruction is acquired. Further, when the line-of-sight direction of any user is not appropriate, the determination unit 13 outputs warning information representing this fact. The warning information may be output to the display device 3 as an image or output from a speaker or the like as speech.

The human error prevention device 1 according to the second embodiment further detects the line-of-sight direction of at least one of the user carrying out a task and the user carrying out confirmation. In addition, the human error prevention device 1 determines that a process corresponding to the input operation is to be performed when the line-of-sight direction is a predetermined line-of-sight direction. That is, the human error prevention device 1 determines whether the line of sight of the user carrying out a task and the line of sight of the user carrying out confirmation are in appropriate directions. For this, it is detected whether each user performs a task while correctly visually recognizing the procedure document and the position of display information of the display device 3. Accordingly, it is possible to further promote mitigation and prevention of human errors. That is, it is possible to more appropriately prevent human errors in a task such as an input operation for a computer.

In the processes of the second embodiment, the determination unit 13 detects line-of-sight directions of both the user carrying out a task and the user carrying out confirmation. However, it is possible to detect whether a line-of-sight direction of at least one user is a predetermined appropriate line-of-sight direction.

The above-described display device 3, the line-of-sight camera 51 or 52 and the microphone 4 may be functions provided in, for example, wearable glasses and the like. The human error prevention device 1 may perform the above-described processes in the same manner in association with a display function, a line-of-sight direction detection function and a speech recognition function provided in wearable glasses. In addition, the procedure document may be displayed on the display device 3.

In addition to the above-described processes, the following processes may be performed. For example, the acquisition unit 12 may sequentially acquire a plurality of pieces of input information in step S204. In addition, when the fact that the input order of the plurality of pieces of input information is an input order corresponding to task identification information has been stated in a condition table, the determination unit 13 may determine that the operation target system 5 is to be caused to perform processes corresponding to the input information.

In this manner, the acquisition unit 12 sequentially acquires a plurality of pieces of task information representing a plurality of input operations on the basis of an operation of the user carrying out a task. When the input order of the plurality of input operations is consistent with an input order stored corresponding to task identification information, the determination unit 13 determines that processes corresponding to the input operations are to be performed. Accordingly, it is possible to more correctly prevent human errors when a task is performed according to a combination of a plurality of input operations.

The above-described human error prevention device 1 and the operation target system 5 have a computer system therein. In addition, each of the above-described processing procedures is stored in a computer-readable recording medium in the form of a program, and the aforementioned processing is performed by a computer reading and executing the program. Here, the computer-readable recording medium refers to a magnetic disk, a magneto-optical disc, a CD-ROM, a DVD-ROM, a semiconductor memory or the like. In addition, the computer program may be transmitted to a computer through a communication link and the computer which has received this transmission may execute the program.

In addition, the aforementioned program may be one for realizing some of the above-described functions. Further, the aforementioned program may be a program which can realize the above-described functions according to a combination with a program already recorded in a computer system, a so-called a difference file (difference program).

Priority is claimed on Japanese Patent Application No. 2017-125138, filed Jun. 27, 2017, the content of which is incorporated herein by reference.

### INDUSTRIAL APPLICABILITY

According to the present invention, the effect of preventing human errors in a task such as an input operation for a computer is obtained.

### REFERENCE SIGNS LIST

1 Human error prevention device
2 Input device
3 Display device
4 Microphone
5 Operation target system
51, 52 Line-of-sight camera
11 Controller
12 Acquisition unit
13 Determination unit
14 Condition table identification unit

1. A human error prevention device comprising:
an acquisition unit configured to acquire task information based on an operation of a user carrying out a task and including task identification information for identifying a task and input information based on an input operation performed in the task corresponding to the task identification information and acquire confirmation completion information based on an operation of a user carrying out confirmation of the input operation; and
a determination unit configured to determine whether to perform a process corresponding to the input operation on the basis of the task information and the confirmation completion information.

2. The human error prevention device according to claim 1, wherein the determination unit is configured to determine that the process corresponding to the input operation is to be performed when it is determined that the task identification information and the input information included in the task information are consistent with each other in a predetermined corresponding relationship, and the task information and the confirmation completion information have been acquired.

3. The human error prevention device according to claim 1, further comprising a line-of-sight direction detection unit configured to detect a line-of-sight direction of at least one of the user carrying out a task and the user carrying out confirmation,
wherein the determination unit is configured to determine that the process corresponding to the input operation is to be performed when the line-of-sight direction is a predetermined line-of-sight direction.

4. The human error prevention device according to claim 1, wherein the acquisition unit is configured to sequentially acquire a plurality of pieces of task information representing a plurality of input operations, and the determination unit is configured to determine that processes corresponding to the input operations are performed when an input order of the plurality of input operations is consistent with an input order stored corresponding to the task identification information.

5. A human error prevention method comprising:
acquiring task information based on an operation of a user carrying out a task and including task identification information for identifying a task and input information based on an input operation performed in the task corresponding to the task identification information and acquiring confirmation completion information based on an operation of a user carrying out confirmation of the input operation; and
determining whether to perform a process corresponding to the input operation on the basis of the task information and the confirmation completion information.

6. A non-transitory computer-readable recording medium storing a program that causes a computer of a human error prevention device to execute processes of:
acquiring task information based on an operation of a user carrying out a task and including task identification information for identifying a task and input information based on an input operation performed in the task corresponding to the task identification information and acquiring confirmation completion information based on an operation of a user carrying out confirmation of the input operation; and
determining whether to perform a process corresponding to the input operation on the basis of the task information and the confirmation completion information.
